(19) United States
(12) Patent Application Publication
(10) Pub. No.: US 2002/0040530 A1
(43) Pub. Date: Apr. 11, 2002

(54) Method and apparatus for using portable band saw

(76) Inventor: Timothy M. Crawley, Glendale, AZ (US)

Correspondence Address: TOD R. NISSLE, P.C., P.O. Box 55630, Phoenix, AZ, 85078, US

(21) Appl. No.: 09/975,038

(22) Filed: Oct. 9, 2001

Related U.S. Application Data
(60) Provisional application No. 60/239,167, filed on Oct. 10, 2000.

(51) Int. Cl. B26D 1/00

(52) U.S. Cl. 30/380; 83/13; 83/661

(57) ABSTRACT

Apparatus for utilizing a portable band saw includes a stand and a key which can be removably slidably secured in the stand. The guide plate is removed from a portable band saw and the key is attached to the saw at the location previously occupied by the guide plate. The key is then slidably secured in the stand to anchor the saw in the stand.

This invention pertains to portable band saws.

More particularly, this invention pertains to a method and apparatus for supporting and using a portable band saw.

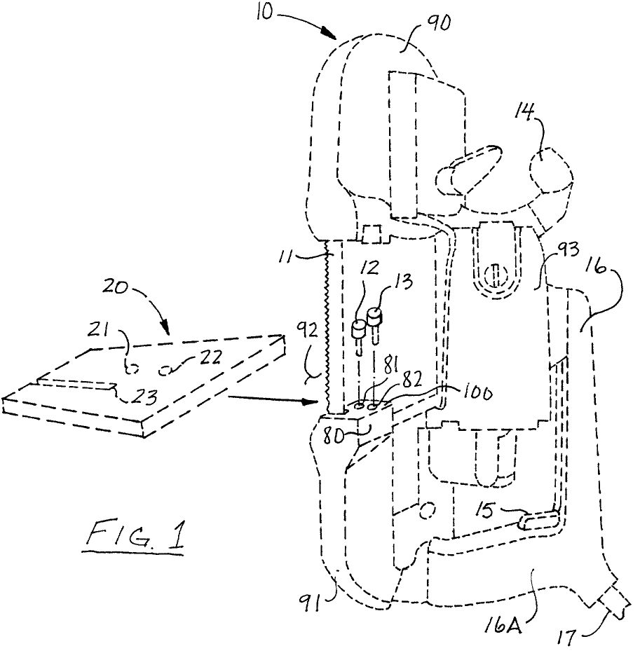

Portable bands saws are well known in the art. In FIG. 1, a Milwaukee portable band saw No. 22739 is identified by reference character 10 and drawn in ghost outline. During normal use of band saw 10, handles 14 and 16 are grasped and trigger 15 is depressed to permit electricity to power the motor 93 which moves band saw blade 11 in work area 92. Band saw 10 includes a small platform, or guide member, (not shown) which normally is attached to band saw 10 by turning externally threaded screws 12, 13 through the guide member into internally threaded apertures 81, 82 formed in the housing of saw 10. When the band saw 10 is being utilized as a portable tool, a workpiece is placed against the guide member to stabilize the workpiece. The blade 11 is then moved into the workpiece to cut the workpiece. As the blade 11 moves into the workpiece, the workpiece slides over the guide member.

On other portable band saws, the screws 12, 13 or other fasteners used to secure the guide member to the band saw housing can extend into apertures formed on a different portion of the housing, for example on the side 80 of the housing.

Saw 10 includes a housing including a pair of opposing pulley housings 90 and 91. A variable speed motor 93 is positioned in the center of the housing and is generally parallel to blade 11. Trigger 15 is in handle 16 and is normally spring loaded in the off position. Depressing trigger 15 provides electric current to motor 93. In use, an operator grasps handle 14 with one hand and grasps handle 16 and depresses trigger 15 with the other hand. The operator then, while grasping handles 14 and 16, guides the exposed section of endless saw blade 11 into a workpiece.

In some instances it is advantageous to use portable saw 10 as a free standing saw table. U.S. Pat. Nos. 5,251,525 and 4,823,666 to Galloway describe support stand kits which receive a portable saw and enable the saw to be utilized in a freestanding configuration.

In U.S. Pat. No. 4,823,666, a hand knob is removed from an internally threaded aperture formed in the saw housing. The internally threaded aperture receives a screw associated with a support stand to secure the saw to the support stand. An auxiliary work table 90 is provided (FIGS. 13 and 14) with the stand and is mounted on the saw after the saw is suspended in the support stand.

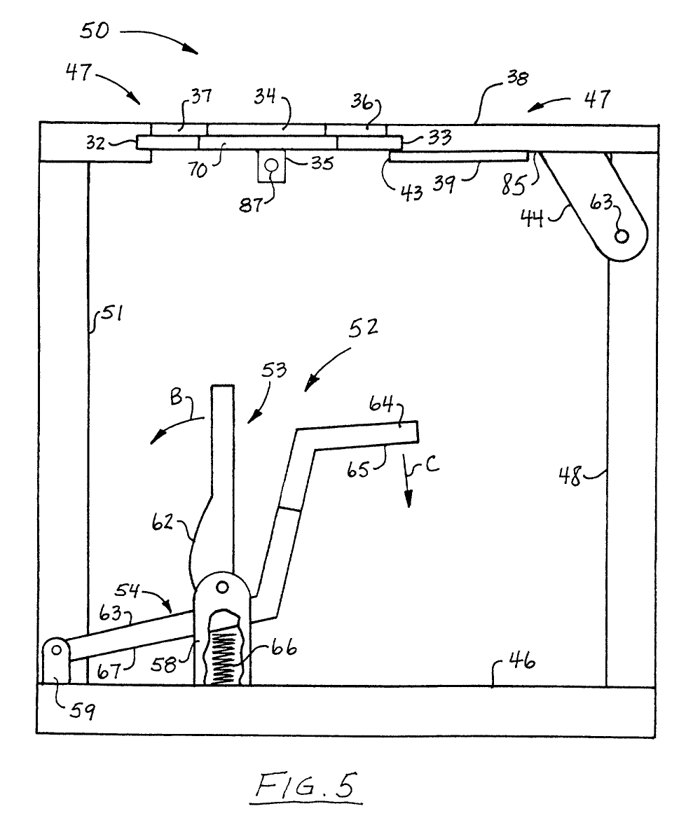

In U.S. Pat. No. 5,251,525, the support stand is shaped to conform snugly to the L-shaped trigger guard. The support stand also includes near the top of the stand a bracket which engages and retains the upper portion of the band saw. An auxiliary work table 100 is provided (FIGS. 7 and 8) with the stand and is mounted on the saw after the saw is suspended in the support stand.

One disadvantage of the support stands in the Galloway patents is that the auxiliary work tables are intended to be attached to portable band saws when the saws are suspended in the support stands.

Another disadvantage is that the support stands can be unstable because the work tables extend beyond the footprint of the support stand.

Accordingly, it would be highly desirable to provide an improved portable band saw support structure which does not require that a support stand be attached as part of a support stand kit after a band saw is suspended in the support structure, and which is stable regardless of where pressure is applied on the work table.

Therefore, it is a principal object of the invention to provide an improved support structure which can be combined with a portable band saw to produce a free standing saw structure.

Another object of the invention is to provide an improved band saw support structure which provides a large work table without requiring the addition of a work table after the saw is mounted in the support structure.

A further object of the invention is to provide an improved band saw support structure that provides a footprint which extends outwardly around and from a band saw mounted on the support structure.

Still another object of the invention is to provide an improved band saw support structure which incorporates a work table as part of the support structure.

These and other, further and more specific objects and advantages of the invention will be apparent to those skilled in the art from the following detailed description thereof, taken in conjunction with the drawings, in which:

FIG. 1 is a perspective view illustrating in phantom outline a portable band saw and the key of the invention utilized in combination therewith;

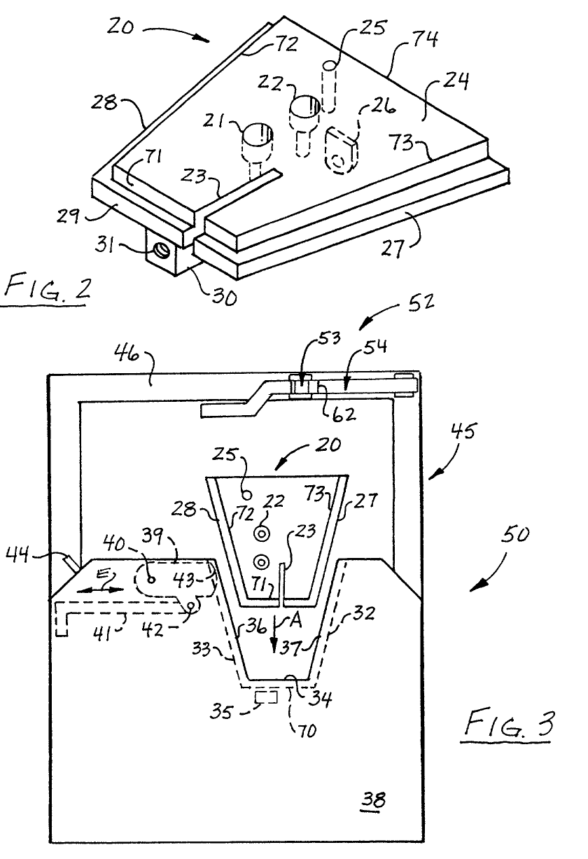

FIG. 2 is a perspective view illustrating additional structural details of the key of FIG. 1;

FIG. 3 is a top view illustrating the mounting of the key of FIG. 2 in a support structure constructed in accordance with the invention;

FIG. 4 is a perspective view further illustrating the support structure of FIG. 3; and,

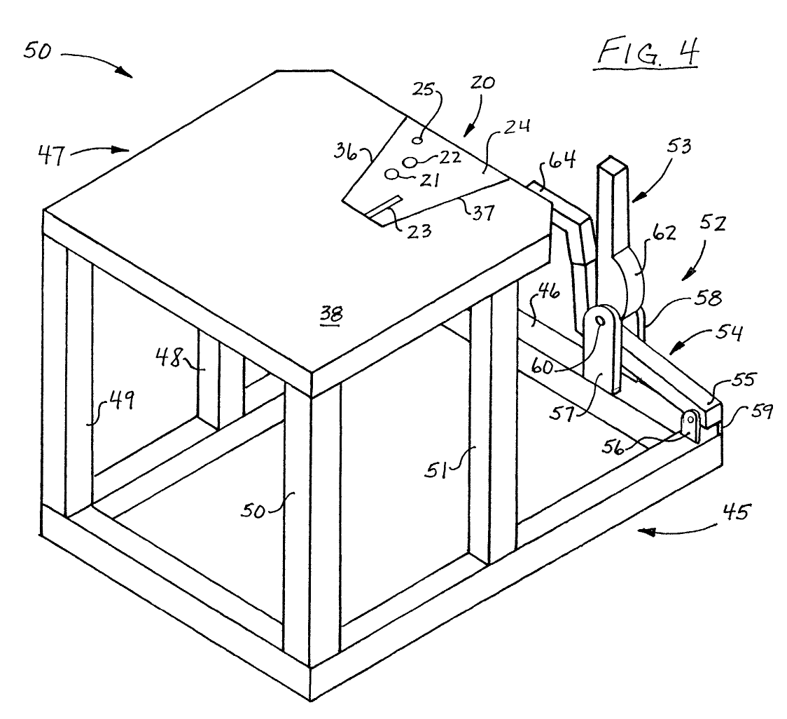

FIG. 5 is a rear elevation view illustrating the support structure of FIG. 4.

Briefly, in accordance with the invention, I provide improvements in combination with a portable band saw. The band saw includes a housing, an endless saw blade mounted in the housing, a motor mounted in the housing to provide motive power to move the saw blade, a handle attached to the housing, a trigger mounted in the handle to control the delivery of electricity to the motor, and fastening apparatus to attach a guide member to the housing adjacent the saw blade. The improvements support the band saw and include a table including a horizontally oriented top; a key attached to the housing of the band saw adjacent the saw blade with the fastening means; and, an opening formed in the table top to slidably receive the key.

In another embodiment of the invention, I provide a method of mounting a portable band saw. The band saw includes a housing, an endless saw blade mounted in the housing, a motor mounted in the housing to provide motive power to move the saw blade, a handle attached to the housing, a trigger mounted in the handle to control the delivery of electricity to the motor, and fastening apparatus to attach a guide member to the housing adjacent the saw blade. The method including the steps of providing a key attachable to the band saw housing with the fastening apparatus; providing a table including a horizontally oriented top, and an opening formed in the top to slidably receive the key; using the fastening means to attach the key to the band saw housing; and, sliding the key into the opening in the top of the table to mount the band saw on the table.

Turning now to the drawings, which depict the presently preferred embodiments of the invention for the purpose of illustrating the practice thereof and not by way of limitation of the scope of the invention, and in which like reference characters refer to corresponding elements throughout the several views, FIGS. 1 illustrates in ghost outline a tapered trapezoidal key 20. A guide member, along with screws 12 and 13, comprises part of the original band saw. This guide member ordinarily is secured in a position adjacent blade 11 with screws 12 and 13. In the practice of the invention, this guide member is removed from saw 10 and set aside.

After the guide member is removed, key 20 is mounted on the housing of band saw 10 by utilizing the screws 12, 13. Screw 12 extends through opening 21 into internally threaded aperture 81. Screw 13 extends through opening 22 into internally threaded aperture 82.

FIG. 2 illustrates key 20 in more detail. Slot 23 is formed to provide an opening through which endless saw blade 11 can pass when key 20 is mounted on the housing of band saw 10. When key 20 is mounted on the housing of saw 10, key 20 functions as a guide member and supports a workpiece which passes over the upper surface 24 of key 20 while the workpiece is cut by blade 11. The upper portion of key 20 includes side edges 72 and 73 each having an end that terminates at front edge 71. The lower portion of key 20 includes side edges 27 and 28 extending outwardly from edges 73 and 72, respectively. An end of each edge 72, 73 terminates at front edge 29.

A set screw 25 in key 20 can be turned clockwise or counterclockwise as desired in order to level key 20 on the housing of the band saw. Screw 25 turns against surface 100.

Tab 26 extends downwardly from key 20. An aperture 20 extends through tab 26. A screw can extend through aperture 20 into the housing of band saw 10 to further secure key 20 on the housing.

Block 30 is attached to the bottom of key 20. Internally threaded aperture 31 extends into block 30.

FIGS. 3, 4, and 5 illustrate a support table 50 constructed in accordance with the invention. Table 50 includes top plate 47 having upper surface 38, includes rectangular base 45, and includes vertically oriented legs 48, 49, 50, 51 interconnecting base 45 and plate 47. Grooves or key ways 32 and 33 (FIG. 5) formed in plate 47 slidably receive edges 27 and 28, respectively, of key 20. Slot or key way 70 receives front edge 29 of key 20. When key 20 is in the position illustrated in FIG. 4, edge 72 is parallel and contacts edge 36, edge 73 is parallel to and contacts edge 37, and, edge 71 is parallel to and contacts edge 34.

Cam lock member 39 (FIG. 3) is pivotally attached by pin 40 to bottom surface 85 (FIG. 5) of top plate 47. Control arm 41 is pivotally attached by pin 42 to an arm formed on member 39. Arm 41 is moved in the direction of arrows E to position edge 43 of member 39 under a portion of edge 28 (when key 20 is mounted on plate 47 in the position illustrated in FIG. 4) or to move edge 43 out from beneath edge 28.

Block 35 is attached to the bottom of top plate 47 and includes cylindrical opening formed therethrough parallel to upper surface 38. When key 20 is inserted in plate 47 and is in the position shown in FIG. 4, apertures 87 and 31 align such that, if desired, an externally threaded screw can be slid through aperture 87 and turned into aperture 31 to further secure key 20 in plate 47 in the position shown in FIG. 4.

Lever assembly 52 includes cam lever 53, lever 54, and spring 66. One end 55 of lever 54 is intermediate wings 56 and 59 and is pivotally attached to the wings 56, 59 with a pin. The lower end of lever 53 is intermediate wings 57 and 58 and is pivotally attached to 57, 58 by pin 60. Spring 66 is positioned between wings 57, 58 and extends between member 46 and lever 54 in the manner illustrated in FIG. 5. Spring 66 forces lever 54 upwardly against the bottom of lever 53 and normally maintains lever 54 in the position shown in FIG. 5. When, however, lever 53 is displaced or pulled in the direction of arrow B (FIG. 5), cam 62 downwardly displaces lever 52 in the direction of arrow C.

Tab 44 includes aperture 63. Tab 44 is positioned such that after key 20 is mounted on saw 10 and key 20 is mounted on table 50 in the position shown in FIG. 4, aperture 63 is positioned adjacent the housing of saw 10 such that a screw can pass through aperture 63 and be turned into an internally threaded aperture formed in the housing of the saw 10 in order to further anchor and stabilize the saw on table 50.

Table 50 is dimensioned such that when saw 10 is mounted on key 20 and key 20 is mounted (along with saw 10) on plate 47 of table 50, the large majority of saw 10 is positioned inside base 45, with only a portion of handle 16 extending a short distance (about 1 inch) outwardly past member 46.

In use, key 20 is positioned on saw 10 such that blade 11 passes through slot 23 and apertures 21 and 22 are aligned with apertures 81 and 82, respectively. Screws 12 and 13 are turned into apertures 81 and 82, respectively, to secure key 20 on saw 10 against vertically oriented surface 100. Key 20 is, with saw 10 attached slidably inserted in top 47 to the position shown in FIG. 4. A screw is passed through aperture 87 (FIG. 5) and turned into internally threaded aperture 31 to further secure key 20 on plate 47. Surface 24 of key 20 is flush with surface 38.

When key 20 (with saw 10 attached thereto) is positioned in plate 47 in the manner illustrated in FIG. 4, trigger 15 and portion 16A of handle 16 are positioned immediately beneath arm 64 of lever 54 such that when lever 53 is displaced in the direction of arrow B and, as a result, arm 64 is downwardly displaced in the direction of arrow C, lower surface 65 of arm 64 depresses trigger 15. When trigger 15 is depressed, electricity flow to motor 93. Once lever 53 is moved in the direction of arrow B to downwardly displace arm 64 and depress trigger 15, lever 53 and arm 64 stay into position until lever 53 is manually raised in a direction opposite that of arrow B to return arm 53 to the position shown in FIG. 5. Consequently, when lever 53 is depressed in the direction of arrow B, saw 10 runs without the operator have to hold down trigger 15 or lever 53.

Having described my invention in such terms as to enable those of skill in the art to make and practice it, and having described the presently preferred embodiments thereof, I claim:

1. In combination with a portable band saw, the band saw including
a housing,
an endless saw blade mounted in the housing,
a motor mounted in the housing to provide motive power to move the saw blade,
a handle attached to the housing,
a trigger mounted in the handle to control the delivery of electricity to the motor,
fastening means to attach a guide member to the housing adjacent the saw blade,
the improvements for supporting the band saw, the improvements including
(a) a table including a horizontally oriented top;
(b) a key attached to the housing of the band saw adjacent the saw blade with the fastening means;
(c) an opening formed in the table top to slidably receive the key.

2. A method of mounting a portable band saw, the band saw including
a housing,
an endless saw blade mounted in the housing,
a motor mounted in the housing to provide motive power to move the saw blade,
a handle attached to the housing,
a trigger mounted in the handle to control the delivery of electricity to the motor,
fastening means to attach a guide member to the housing adjacent the saw blade,
the method including the steps of
(a) providing a key attachable to the band saw housing with the fastening means;
(b) providing a table including
(i) a horizontally oriented top, and
(ii) an opening formed in the top to slidably receive the key;
(c) using the fastening means to attach the key to the band saw housing; and,
(d) sliding the key into the opening in the top of the table to mount the band saw on the table.
